(19) United States
(12) Patent Application Publication
(10) Pub. No.: US 2011/0176584 A1
(43) Pub. Date: Jul. 21, 2011

(54) COMMUNICATION SYSTEM AND COMMUNICATION METHOD

(75) Inventors: Shunsuke KIKUCHI, Kawasaki (JP); Yuji Imai, Kawasaki (JP)

(73) Assignee: FUJITSU LIMITED, Kawasaki-shi (JP)

(21) Appl. No.: 13/007,016

(22) Filed: Jan. 14, 2011

(30) Foreign Application Priority Data
Jan. 20, 2010 (JP) 2010-010380

(51) Int. Cl. H04B 3/36

(52) U.S. Cl. 375/211

(57) ABSTRACT

A communication system including: a first device that includes first and second units and a first encapsulation unit encapsulating data; a second device that includes a third unit communicating data with the second unit, a fourth unit, and a second encapsulation unit encapsulating data; a third device that includes a fifth unit communicating data with the first or third unit, a sixth unit, and a third encapsulation unit encapsulating data; and a fourth device that includes a seventh unit communicating data with the first or third unit, an eighth unit communicating data with the fifth unit, and a fourth encapsulation unit encapsulating data; wherein at least two of the first to fourth devices include control units that control the units that the at least two of the first to fourth devices have, so as not to transfer received data to other devices.

### CROSS-REFERENCE TO RELATED APPLICATION

This application is based upon and claims the benefit of priority of the prior Japanese Patent Application No. 2010-010380, filed on Jan. 20, 2010, the entire contents of which are incorporated herein by reference.

### FIELD

The present invention relates to a communication system and a communication method.

### BACKGROUND

In recent years, “tunneling” has been used for communication using data encapsulated by adding a further header to data including a header.

For example, by communicating encapsulated data obtained by encapsulating data of a communication protocol A with a communication protocol B over a network operated with the communication protocol B, it is possible to connect two networks operated with the communication protocol A by a closed, virtually direct communication route.

A communication protocol, like the above communication protocol B, for encapsulating data is called a “tunneling protocol”. The EtherIP and GRE (Generic Routing Encapsulation) may be mentioned as examples of tunneling protocols enabling tunneling even in broadcast data transmission.

On the other hand, when connecting two networks of differing subnets by tunneling, routers etc. for performing segmentation are arranged at either of the two networks. In such a case, even if tunneling broadcast data transmission, the broadcast data will end up being blocked by the routers.

For this reason, the networks connected by tunneling are made networks of the same subnet so as to enable the transfer of broadcast data to the two networks connected by tunneling.

As related art, see the IETF, Network Working Group, Generic Routing Encapsulation, RFC (Request for Comments) 1701 and the IETF, Network Working Group, EtherIP: Tunneling Ethernet Frames in IP Datagrams, RFC (Request for Comments) 3378.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### SUMMARY

Accordingly, it is an object in one aspect of the embodiment to provide a communication system including: a first communication device that includes first and second communication units and a first encapsulation unit encapsulating or decapsulating data communicated by the first communication unit; a second communication device that includes a third communication unit communicating data with the second communication unit, a fourth communication unit, and a second encapsulation unit encapsulating or decapsulating data communicated by the third communication unit; a third communication device that includes a fifth communication unit communicating data with the first or third communication unit, a sixth communication unit, and a third encapsulation unit encapsulating or decapsulating data communicated by the fifth communication unit; and a fourth communication device that includes a seventh communication unit communicating data with the first or third communication unit, an eighth communication unit communicating data with the fifth communication unit, and a fourth encapsulation unit encapsulating or decapsulating data communicated by the seventh communication unit; wherein each of the first to fourth communication devices includes a control unit controlling the communication units and the control units of at least two of the first to fourth communication devices control the communication units so as not to transfer data received from other communication devices to these other communication devices.

### BRIEF DESCRIPTION OF DRAWINGS

These and other objects and features will become clearer from the following description of the preferred embodiments given with reference to the attached drawings, wherein:

FIG. 1 is a block diagram illustrating one example of the configuration of a communication system;

FIG. 2 is a block diagram illustrating one example of the functions of a communication device;

FIG. 3A is a block diagram illustrating one example of a communication route;

FIG. 3B is a block diagram illustrating one example of a tunnel route established by tunneling;

FIG. 4 is a network diagram illustrating one example of information which a storage unit stores;

FIG. 5A is a network diagram illustrating one example of a tunnel route;

FIG. 5B is a network diagram illustrating one example of a tunnel route;

FIG. 5C is a network diagram illustrating one example of a tunnel route;

FIG. 5D is a network diagram illustrating one example of a tunnel route;

FIG. 5E is a network diagram illustrating one example of a tunnel route;

FIG. 6 is a flowchart illustrating one example of communication control performed by a communication device;

FIG. 7 is a network diagram illustrating one example of a network configuration at which a backbone communication device is set at a tunnel side network;

FIG. 8 is a sequence diagram illustrating an example of restoration of a communication system from a fault occurring at a tunnel side network;

FIG. 9 is a sequence diagram illustrating one example of restoration of a communication system from a fault occurring in a communication device; and

FIG. 10 is a network diagram illustrating one example of a tunnel route after restoration from a fault.

### DESCRIPTION OF EMBODIMENTS

As described previously, the networks connected by tunneling are made networks of the same subnet. However, depending on the configurations of the networks connected by tunneling, sometimes a loop forms inside the tunneling. For example, if connecting in a ring two tunneling devices redundantly configured at one network and two tunneling devices redundantly configured at the other network, a loop-shaped communication route will be formed.

In transmission of broadcasts over a communication route forming such a loop, the broadcast packets will repeatedly loop around the four tunneling devices while the broadcast is transmitted to all ports of the tunneling devices, so communication will be disabled.

It is however possible to prevent broadcast packets from ending up looping inside a network.

Below, an embodiment of a communication system will be explained with reference to the drawings.

[Configuration of Communication System]

<Communication Devices>

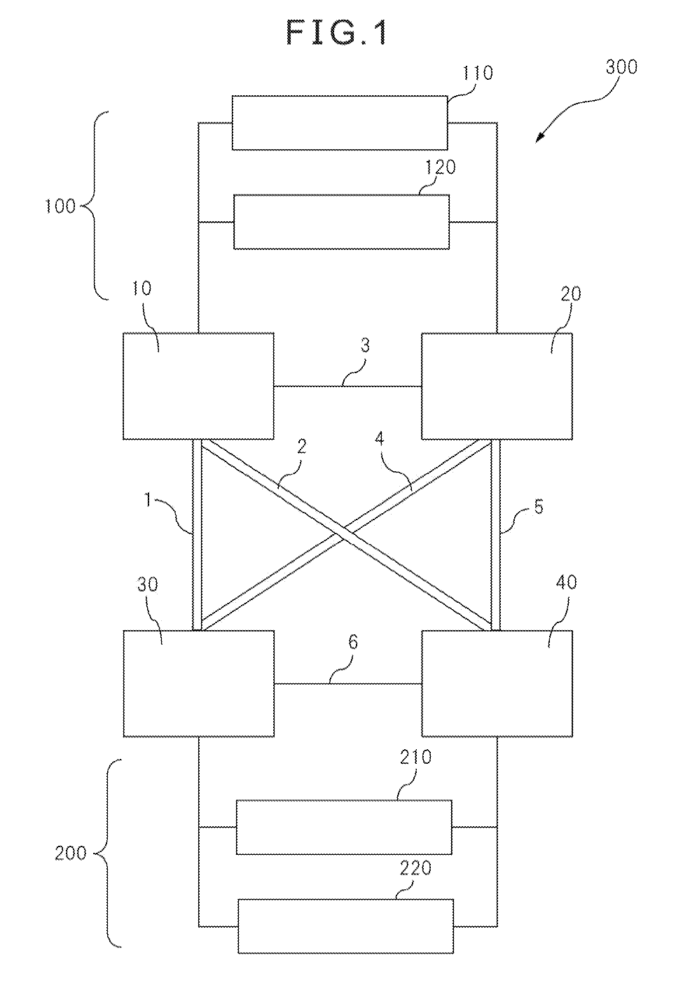

The communication system 300 illustrated in FIG. 1 has communication devices 10 to 40. The communication devices 10 and 20 form a redundant configuration. They connect with the information processing devices 110 and 120 and form a network 100. The communication devices 30 and 40 also form a redundant configuration. They connect with the information processing devices 210 and 220 and form a network 200.

The redundantly configured communication devices 10 to 40 form active redundancy systems. All are in the operating state. In an active redundancy system, even if one of the redundantly configured communication devices starts having trouble operating, the other communication device continues to operate, so this is superior in reliability and practicality compared with a standby redundancy system in which the redundantly provided device is in a standby state at the time of normal operation.

The illustrated network 100 and network 200 are networks of the same subnet. The communication devices 10 to 40 may form the network 100 and the network 200 by different VLANs (Virtual Local Area Networks) or by the same VLAN.

Note that, in the following explanation, a network in which communication devices and information processing devices are connected will be referred to as an “inside network”, while a network between communication devices will be referred to as a “tunnel side network”. Further, the direction of data transmission from a communication device to the tunnel side network will be referred to as the “tunnel side”, while the direction of data transmission from a communication device to the inside network will be referred to as the “inside”.

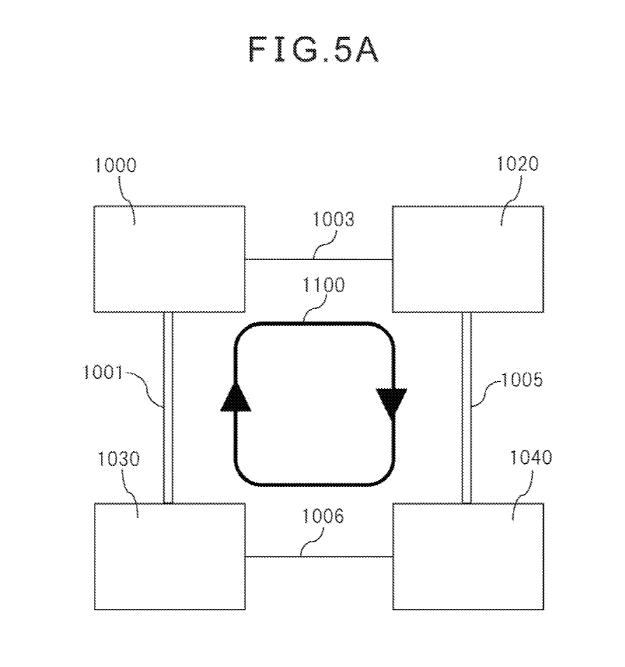

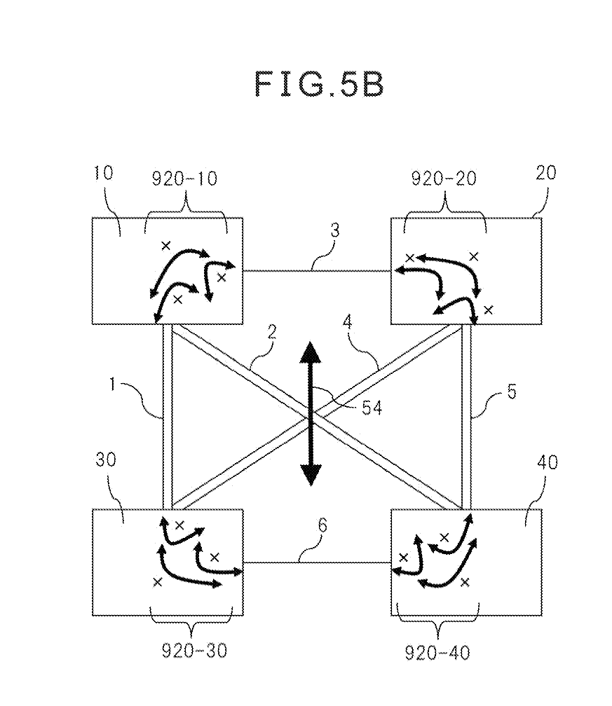

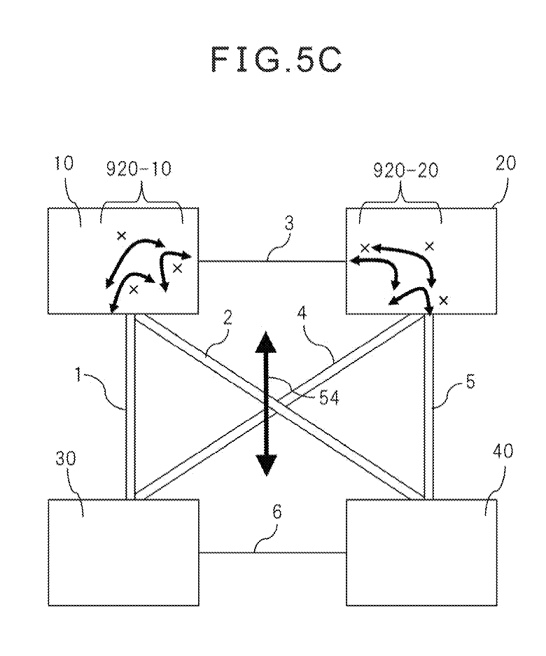

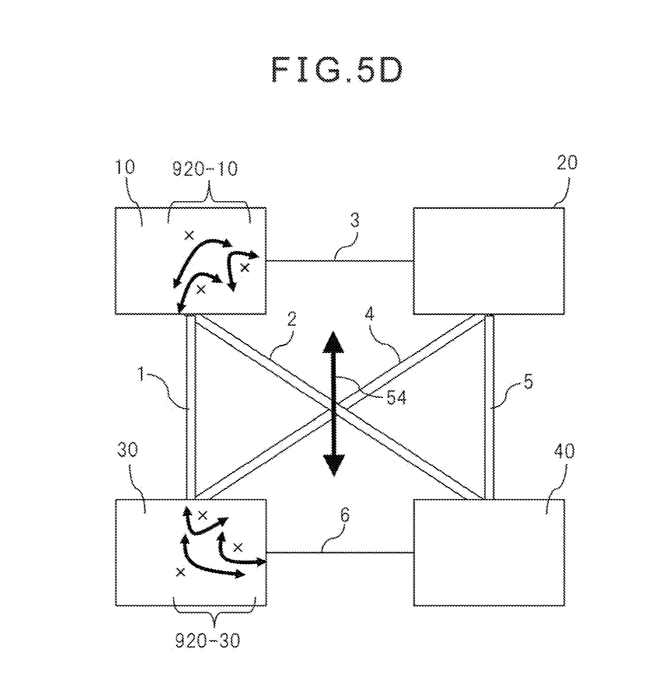

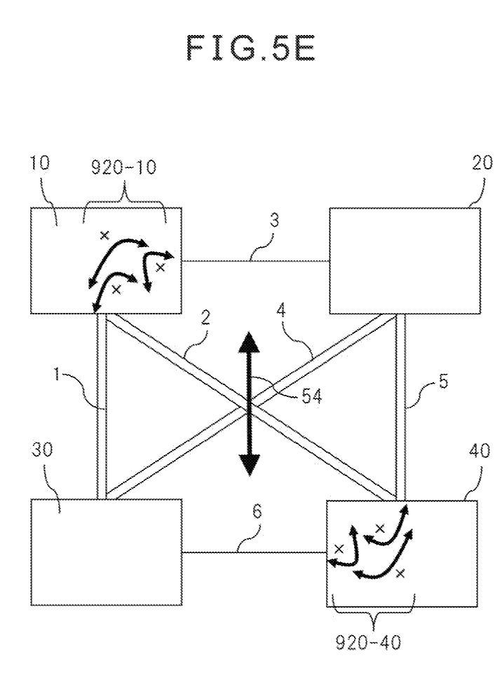

Reference numerals 1, 2, 4, and 5 are virtual communication routes, that is, “tunnel routes” established with other communication devices by communication devices which encapsulate data. As explained later, a tunnel route is a virtual communication route established after communication devices authenticate each other on an actual network. For this reason, in an actual network configuration, the communication devices 10 to 40 may be any of ring types, star types, or full connect types, but the communication route between communication devices formed by the tunneling becomes a ring type or full connect type network configuration. The relationship between a communication route formed by such an actual network configuration and a tunnel route established by tunneling will be explained later using FIG. 5A to FIG. 5E. Data to be transmitted to another communication device is encapsulated by the communication devices by, for example, the EtherIP or GRE. The communication routes 3 and 6 are communication routes between the communication device 10 and communication device 20 and decapsulated data is transferred over the communication routes. They are “crossovers” serving as cables connecting two redundantly configured communication devices.

The communication device 10 and the communication device 20 form a redundant configuration. Even if one of the communication device 10 and communication device 20 breaks down, the other communication device can connect through a tunnel route to the communication device 30 or communication device 40.

The communication device 10 connects through a tunnel route 1 to the communication device 30, through a tunnel route 2 to the communication device 40, and through a communication route 3 to the communication device 20. The communication device 20 connects through a communication route 3 to the communication device 10, through a tunnel route 4 to the communication device 30, and through a tunnel route 5 to the communication device 40.

The communication device 30 and the communication device 40 form a redundant configuration. Even if one of the communication device 30 and communication device 40 breaks down, the other communication device can connect through a tunnel route to the communication device 10 or communication device 20.

The communication device 30 connects through the tunnel route 1 to the communication device 10, through the tunnel route 4 to the communication device 20, and through the communication route 6 to the communication device 40. The communication device 40 connects through the tunnel route 2 to the communication device 10, through the tunnel route 5 to the communication device 20, and through the communication route 6 to the communication device 30.

<Information Processing Devices>

The information processing devices 110 and 120 are connected in the network 100, while the information processing devices 210 and 220 are connected in the network 200. The information processing devices 110, 120, 210, and 220 respectively have two network interfaces. The information processing devices 110 and 120 use either of the network interfaces to connect to the communication device 10 or communication device 20. The information processing devices 210 and 220 use either of the network interfaces to connect to the communication device 30 or communication device 40. The network interfaces are, for example, NICs (Network Interface Cards) and use twisted pair cables or optical fiber cables to connect to the communication devices.

<Example of Application of Communication System>

The communication system 300 can, for example, be arranged at a data center. In a data center accommodating systems of a plurality of customers, the respective customer systems are isolated from each other in the data center so that they cannot be mutually recognized. The information processing devices 110 to 220 are, for example, servers and operate as customer systems. The information processing devices 110 to 220 operating as customer systems, for example, are arranged dispersed separately in racks in the data center in accordance with the timing of installation in the data center, expansion after installation (increase in number of units), etc. The information processing devices 110 to 220 are connected to each other by the networks 100 and 200 and form a system including customer system units of single servers and networks 100 and 200. To isolate the networks, in the data center, the physical network is logically divided by a VLAN and the divided networks are allocated to the customer systems.

For example, the information processing devices 110 and 120 connected to the network 100 are arranged at the same racks, while the information processing devices 210 and 220 connected to the network 200 are arranged at the same racks. The networks 100 and 200 are, for example, networks of the same subnet. They may be differentiated from each other by the VLAN. The information processing devices for running the customer systems are not formed completely in the racks. When connecting racks with each other, the networks are connected with each other by the tunnel routes 1, 2, 4, and 5. The communication devices 10 to 40 are arranged at racks. Tunnels are set up between the devices.

[Configuration of Communication Devices]

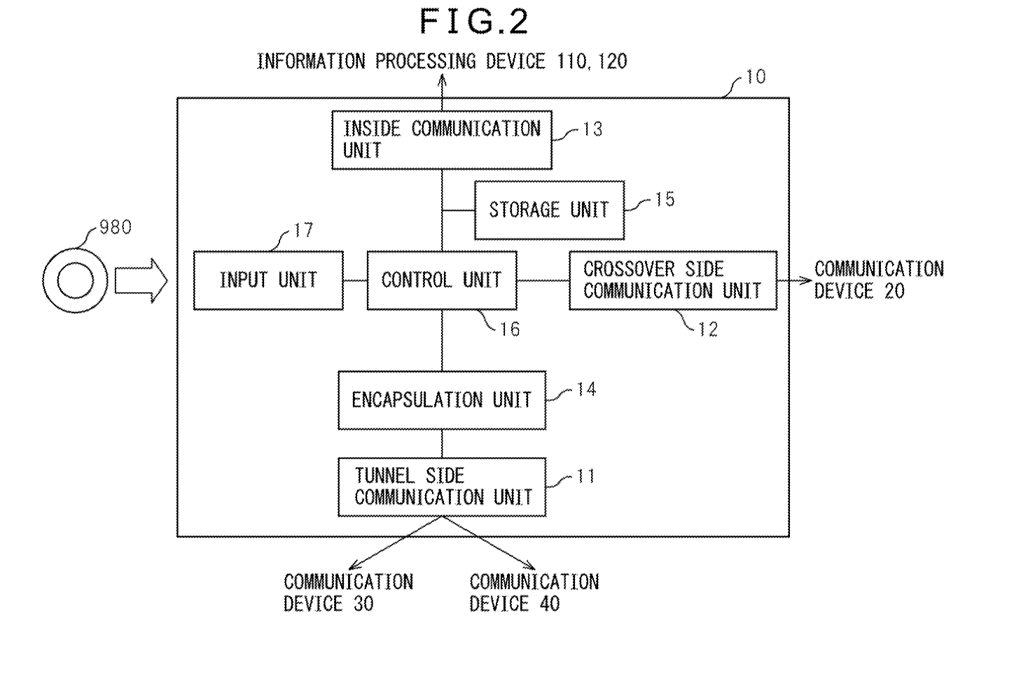

Using FIG. 2 to FIG. 5, one example of the configuration of a communication device will be explained. FIG. 2 is a block diagram illustrating one example of the component elements of the communication device.

The communication device 10 has a tunnel side communication unit 11, crossover side communication unit 12, inside communication unit 13, encapsulation unit 14, storage unit 15, control unit 16, and input unit 17. The communication devices 10 to 40 may have the same component elements. While not illustrated in FIG. 2, the other communication devices 20 to 40 may also have corresponding component elements. For example, the communication device 20 has a tunnel side communication unit 21, crossover side communication unit 22, inside communication unit 23, encapsulation unit 24, storage unit 25, control unit 26, and input unit 27. The communication device 30 has a tunnel side communication unit 31, crossover side communication unit 32, inside communication unit 33, encapsulation unit 34, storage unit 35, control unit 36, and input unit 37. The communication device 40 has a tunnel side communication unit 41, crossover side communication unit 42, inside communication unit 43, encapsulation unit 44, storage unit 45, control unit 46, and input unit 47. The explanation of component elements of the communication device 10 explained below may also be applied to the corresponding component elements of the other communication devices 20 to 40.

<Communication Unit>

The tunnel side communication unit 11 is a communication unit which sends and receives encapsulated packets. It is an interface device which connects with other communication devices 30 and 40 connected to the tunnel side network through tunnel routes. The tunnel side communication unit 11 adds header information to a payload provided from the encapsulation unit 14 in accordance with header information provided by the encapsulation unit 14.

The crossover side communication unit 12 is an interface device which connects to redundantly configured communication devices.

The inside communication unit 13 is a connection interface device which transmits and receives decapsulated packets with information processing devices 110 and 120 both connected in the network 100.

The tunnel side communication unit 11, crossover side communication unit 12, and inside communication unit 13 control communication in accordance with, for example, the Ethernet® or other communication protocol and use twisted pair cables or optical fiber cables to communicate with the communication devices or information processing devices. The tunnel side communication unit 11 is identified by an IP (Internet Protocol) address of the tunnel side network, while the crossover side communication unit 12 and inside communication unit 13 are identified by IP addresses of the inside network.

<Encapsulation Unit>

The encapsulation unit 14 adds a further additional header to data including a header sent from the control unit 16, as encapsulation processing. In other words, the encapsulation unit 14 provides data received from the information processing device 110 etc., as a payload, to the tunnel side communication unit 11 and instructs the tunnel side communication unit 11 to perform processing for adding an additional header. The additional header includes, for example, the IP address of the tunnel side communication unit 11 at the tunnel side network and tunnel identification information. Tunnel identification information is prepared corresponding to the number of tunnel routes established. For example, when the communication device 10 establishes a tunnel route between the communication device 30 and communication device 40, there are two sets of tunnel identification information: tunnel identification information for the tunnel route with the communication device 30 and tunnel identification information for the tunnel route with the communication device 40.

The encapsulation unit 14 utilizes a connection established by the tunnel side communication unit 11 by, for example, the TCP (Transmission Control Protocol), and performs authentication with the encapsulation unit of the destination using tunnel identification information included in the header, that is, performs tunnel authentication. When the tunnel is authenticated, the tunnel is established and a tunnel route is established between the communication devices. Depending on the type of the tunneling protocol, there are also protocols with no tunnel authentication procedures. In this case, there is no need for performing an authentication procedure.

The encapsulation unit 14 decapsulates data received from an outside network through the tunnel side communication unit 11 by removing communication use header information at the outside network and obtains the payload from the data received at the tunnel side communication unit 11.

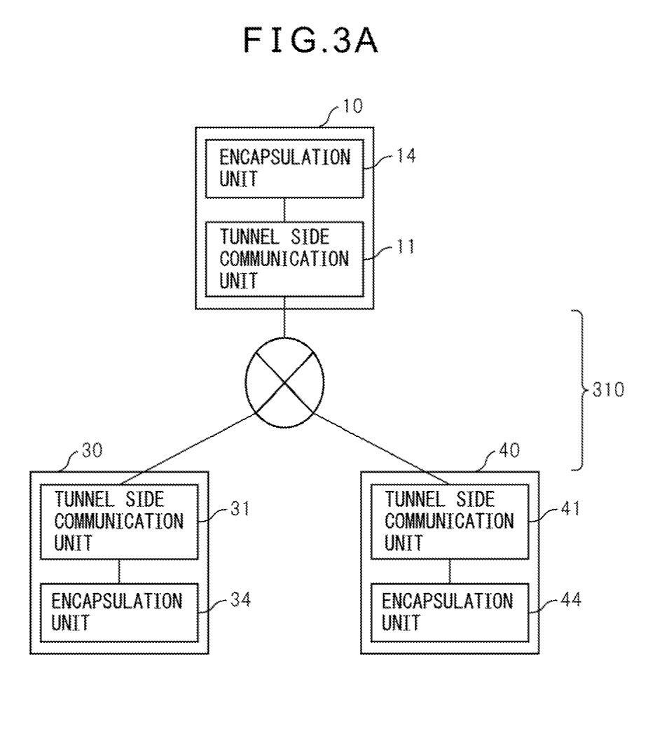

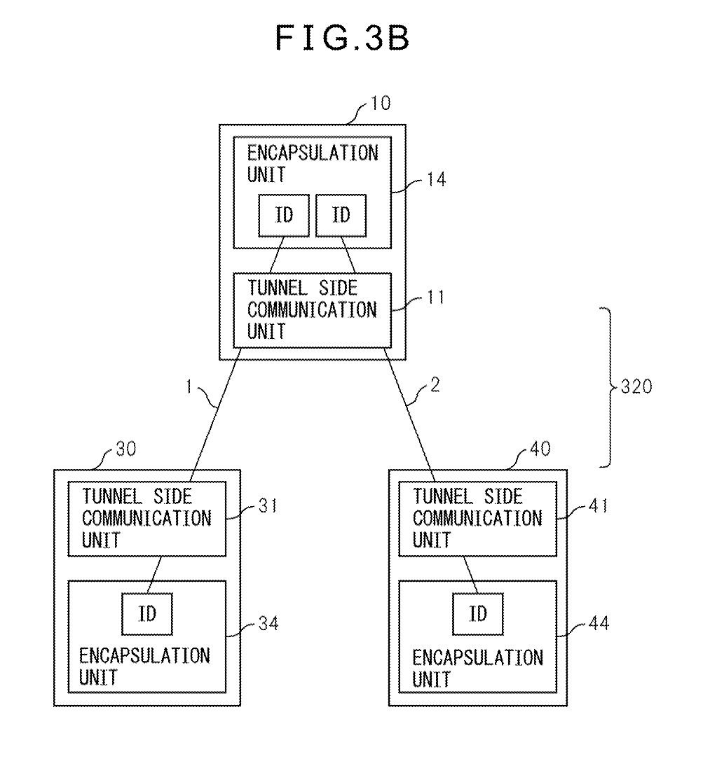

Using FIG. 3A and FIG. 3B, one example of a tunnel route established by the encapsulation unit 14 will be explained. Reference numeral 310 illustrated in FIG. 3A is a physical communication route of the tunnel side network, while 320 illustrated in FIG. 3B is a tunnel route formed by establishment of tunneling.

The encapsulation unit 14 refers to the later explained tunnel information 910 and uses the tunnel side communication unit 11 to establish a control connection for the tunnel destination address in accordance with, for example, the TCP. FIG. 3A is a block diagram illustrating one example of a communication route connecting communication devices. The tunnel side communication units 11, 31, and 41 of the communication devices establish control connection through the physical network 310 illustrated in FIG. 3A.

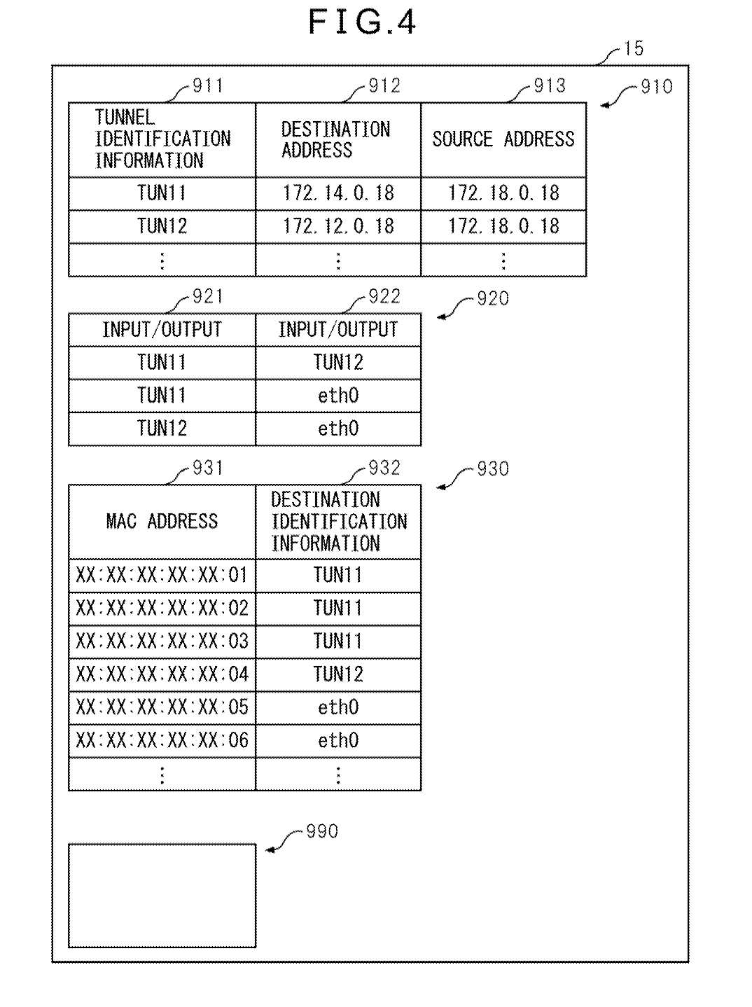

The encapsulation unit 14 further refers to the data transfer table 930 (FIG. 4) and performs authentication with the encapsulation unit 34 or encapsulation unit 44 of the destination other communication device so as to establish a tunnel route. The encapsulation unit 14 provides a tunnel route for the data including the authenticated tunnel identification information. For example, by using the physical communication route illustrated in FIG. 3A to establish a tunnel route, as illustrated in FIG. 3B, tunnel routes 1 and 2 are established. Thus, the communication device 10 establishes a tunnel route 1 and a tunnel route 2 respectively with the communication devices 30 and 40. Thus, the encapsulation unit 24 establishes tunnel routes separately for the number of tunnel connections for each communication device to be connected. Note that, in the case of tunneling protocol with no authentication procedures, tunnel routes can be established and tunnel routes can be provided without authentication procedures.

<Storage Unit>

The storage unit 15 stores information illustrated in FIG. 4 such as tunnel information 910, filter rules 920, a data transfer table 930, and a program 990.

<Tunnel Information>

The tunnel information 910 is information linking the IP addresses of the tunnel side network and the tunnel identification information. The tunnel information 910 has entries (rows) for each tunnel identification information. The entries have input values of the tunnel identification information column 911, destination IP address column 912, and source IP address column 913. In the example illustrated in FIG. 4, the tunnel identification information column 911 has the input tunnel identification information, the destination IP address column 912 has the input IP addresses of the communication device 30 and communication device 40, while the source IP address column 913 has the input IP addresses of the communication device 10. For example, the communication device 10 has the tunnel routes 1, 2 to the communication device 30 and the communication device 40, so there are two sets of tunnel identification information. Further, the tunnel information 910 has, as input, the destination address and source address for each tunnel identification information.

The control unit 16 takes tunnel information 910 received through the input unit or outside or an inside network and stores it in the storage unit 15 and provides it to the encapsulation unit 14. The encapsulation unit 14 uses the tunnel information 910 to perform tunnel authentication with the communication device establishing the tunnel route, by using the tunnel identification information corresponding to the IP address of the communication device.

<Filter Rules>

The filter rules 920 are information specifying the input/output units which stop data transfer. The control unit 16 follows the filter rules 920 to control communication at the tunnel side communication unit 11 and crossover side communication unit 12. The filter rules 920 have entries (rows) for each set of input/output for which data transfer is controlled. Each entry has input values of the input/output columns 921 and 922. As illustrated in FIG. 4, the input/output columns 921 and 922 have tunnel identification information of the tunnel side communication unit 11, that is, “TUN11” or “TUN12”, and the name of the crossover side communication unit 12, that is, “eth0”, input to them.

<Data Transfer Table>

The data transfer table 930 includes destination addresses of data received from the information processing device and information linking them with the communication unit. The control unit 16 refers to the data transfer table 930 and performs processing for transferring the received data to the corresponding communication unit. The data transfer table 930 has entries for each MAC (Media Access Control) address. The entries have the input values of the destination MAC address column 931 and destination name column 932. As illustrated in FIG. 4, the destination MAC address column 931 has the destination MAC addresses input to it, while the destination name column 932 has the tunnel identification information of the communication unit or encapsulation unit, that is, “TUN11” or “TUN12”, and the crossover side communication unit, that is, “eth0”, input to it.

<Control Unit>

The control unit 16 controls the tunnel side communication unit 11 and the crossover side communication unit 12 in accordance with the data transfer table 930 and filter rules 920 in the storage unit 15. For example, the control unit 16 performs communication control processing to control the tunnel side communication unit 11 and crossover side communication unit 12 so as not to transfer data received from another communication device to another communication device. Note, the communication control processing performed by the control unit 16 and the control of other devices can be realized by running the program 990. FIG. 5A illustrates one example of a loop 1100 formed among the communication device 10 to communication device 40. To avoid the formation of such a loop 1100, at least two of the communication devices 10 to 40 control the transmission of received data in accordance with filter rules 920 stored in the storage unit.

FIG. 5B to FIG. 5E is a network diagram illustrating one example of a tunnel route. For example, the filter rule indicated by 920-10 prohibits data communication, through the communication device 10, between the communication device 20 and communication device 30, data communication between the communication device 20 and communication device 40, and data communication between the communication device 30 and communication device 40. The filter rule indicated by 920-20 prohibits data communication, through the communication device 20, between the communication device 10 and communication device 40, data communication between the communication device 10 and communication device 30, and data communication between the communication device 30 and communication device 40. Further, the filter rule indicated by 920-30 prohibits data communication, through the communication device 30, between the communication device 10 and communication device 40, data communication between the communication device 10 and communication device 20, and data communication between the communication device 20 and communication device 40. Furthermore, the filter rule indicated by 920-40 prohibits data communication, through the communication device 40, between the communication device 10 and communication device 20, data communication between the communication device 10 and communication device 30, and data communication between the communication device 20 and communication device 30.

As illustrated by the data communication 54, the tunnel routes 1, 2, 4, and 5 are established so as to enable a communication of encapsulated data between the communication device 10 or communication device 20 and the communication device 30 or communication device 40.

FIG. 5C illustrates the case where the filter rule 920-10 and filter rule 920-20 are applied to the communication device 10 and communication device 20. FIG. 5D illustrates the case where the filter rule 920-10 and filter rule 920-30 are applied to the communication device 10 and communication device 30. FIG. 5E illustrates the case where the filter rule 920-10 and filter rule 920-40 are applied to the communication device 10 and communication device 40.

As illustrated in FIG. 5C to FIG. 5E, if any two of the filter rules 920-10, 920-20, 920-30, and 920-40 are applied to the communication devices 10 to 40, the loop 1100 illustrated in FIG. 5A does not occur. For this reason, without applying the filter rules to the communication devices 10 to 40, it is also possible to apply two filter rules to any two communication devices of the communication devices 10 to 40.

The input unit 17 is an input unit which can set the tunnel information 910 and filter rules 920, for example, a keyboard. Further, the input unit 17 may also function as a drive unit which reads out a program 990 from a storage medium 980 (FIG. 2) storing the program 990. Note, the tunnel information 910 and the filter rules 920 may also be received from an outside information processing device.

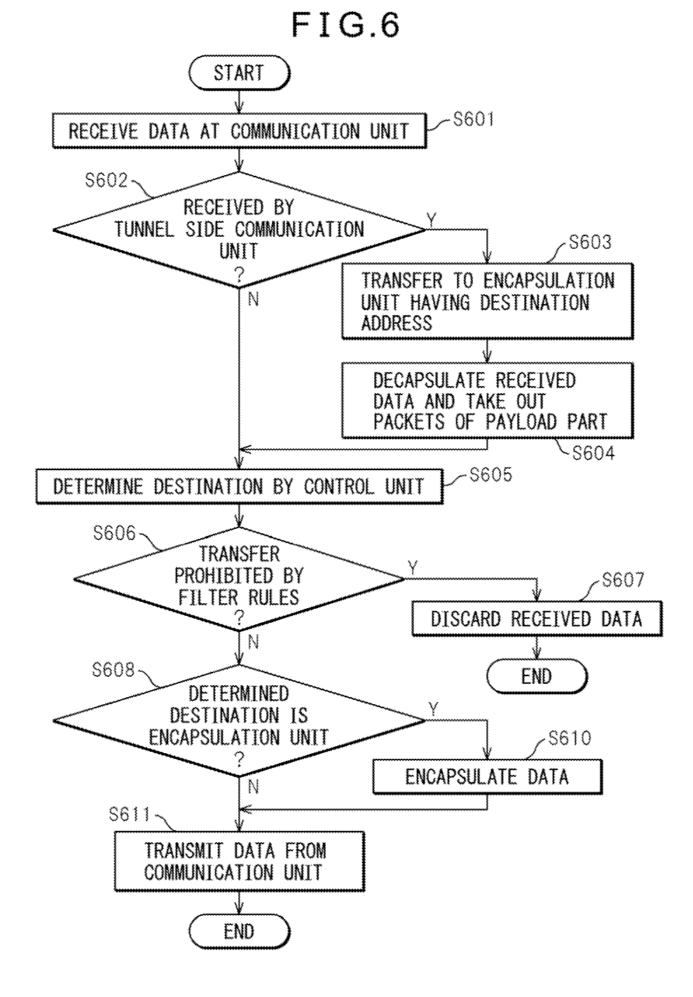

FIG. 6 is a flowchart illustrating an example of the communication control performed by a communication device. Either of the inside communication unit 13, crossover side communication unit 12, or tunnel side communication unit 11 receives data (S601). When data received by the tunnel side communication unit 11 (S602, Y), the tunnel side communication unit 11 transfers the data to the encapsulation unit 14 of the destination address of the received data (S603). The tunnel side communication unit 11 decapsulates the packets to take out the packets at the payload part (S604), then the routine proceeds to step S605.

When no data is received at the tunnel side communication unit 11 (S602, N), the routine proceeds to step S605. The control unit 16 refers to the data transfer table 930 and determines the destination of the received data (S605). The control unit 16 refers to the filter rules 920 and judges if the destination of the received data is a destination to which transmission is prohibited by the filter rules (S606). When the destination of the received data is prohibited by the filter rules (S606 Y), the control unit 16 discards the received data (S607) and ends the processing. When the destination of the received data is not prohibited by the filter rules (S606 N), the control unit 16 proceeds to step S608.

The control unit 16 judges if the destination determined at step S605 is a communication unit or encapsulation unit (S608). When the determined destination is an encapsulation unit (S608, Y), the control unit 16 transfers the received data to the encapsulation unit. The encapsulation unit 14 encapsulates the received data (S610), then the routine proceeds to step S611. When the determined destination is not the encapsulation unit (S608, N), the routine proceeds to step S611. At step S611, the tunnel side communication unit 11 or crossover side communication unit 12 transmits the data and ends the processing.

[Processing of Abnormality of Communication System]

The operation for monitoring the communication system 300 and the operation for dealing with trouble when it occurs will be explained for each abnormality envisioned. Note, the communication devices 10 to 40 performs the monitoring operation and troubleshooting operation in parallel with the above data communication processing.

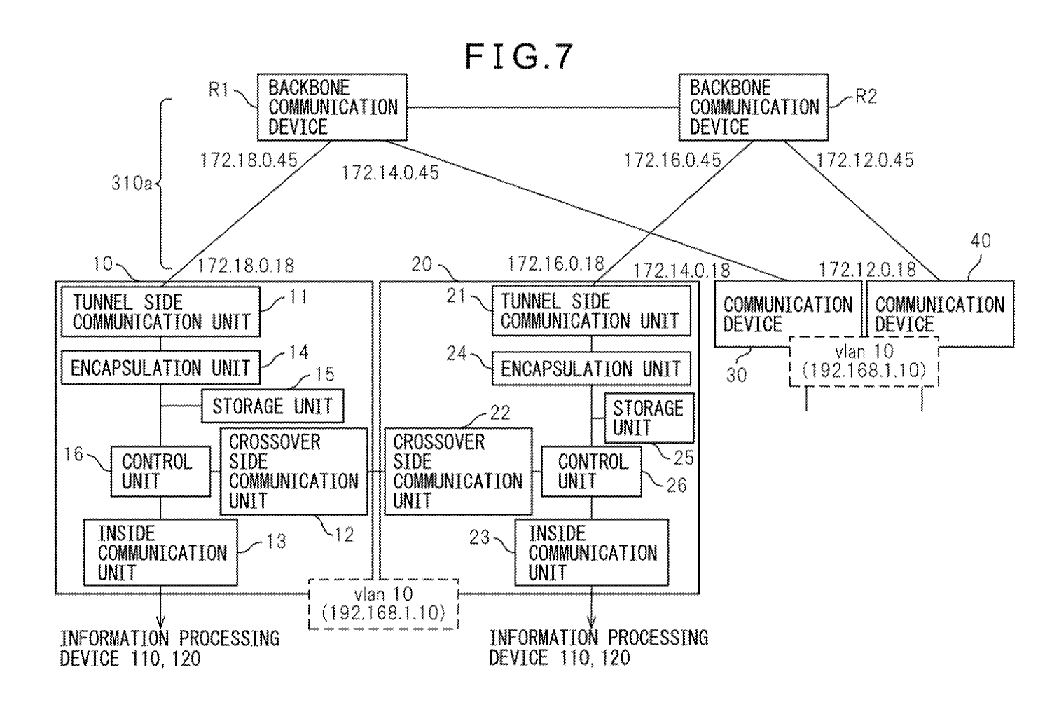

FIG. 7 is a network diagram illustrating one example of the network configuration in which backbone communication devices are set at the tunnel side network. As illustrated in FIG. 7, the communication devices 10 to 40 are connected to the backbone communication devices R1 and R2 through a network 310a. Reference numeral 310a corresponds to the network 310 illustrated in FIG. 3A and is not a tunnel route. As illustrated in FIG. 7, the tunnel side network and the inside network differ in subnets. The tunnel side communication unit has, at the tunnel side, an IP address of the address system of the tunnel side network. Further, the inside communication unit has an IP address of the address system of the inside network at the inside. The backbone communication devices R1 and R2 are communication devices used for segmentation of the tunnel side network and, for example, consist of a router or L3 (Layer 3) switch.

<Monitoring of Communication Device>

After the establishment of a tunnel, a communication device transmits a heart beat packet to the other communication device to thereby monitor if the other communication device is operating normally or if the backbone communication device is operating normally. To separate faults of the backbone communication device and other communication devices, for example, it may designate their respective IP addresses and judge if there is a PING response. When not receiving a confirmation packet from the destination communication device, it may stop the processing for continuing to send packets to a communication device which has gone down due to a fault. Furthermore, it generates a transmission table so as to send data to the redundantly configured communication device side. Further, the communication device monitors the statuses of the communication units and uses the states to monitor if the backbone communication device is operating normally.

Further, the communication device transmits a heart beat packet through the crossover side communication unit to the redundantly configured other communication device to monitor if the redundantly configured other communication device is normally operating. Further, the communication device may monitor the state of the communication unit and, from that state, monitor if the redundantly configured other communication device is normally operating.

In this way, the communication devices 10 to 40 can constantly monitor if the other communication devices are normally operating.

Note, the communication devices 10 to 40 detect the MAC addresses of the sources and destinations to generate communication tables linking the sources and destinations of MAC addresses. For this reason, when the other communication devices stop operating, the communication devices 10 to 40 discard the communication tables and perform processing for preparing the communication tables again.

<Occurrence of Fault at Tunnel Side Network>

As faults at the tunnel side network, an open circuit at the tunnel side network, a fault at the backbone communication devices R1, R2, etc. may be mentioned.

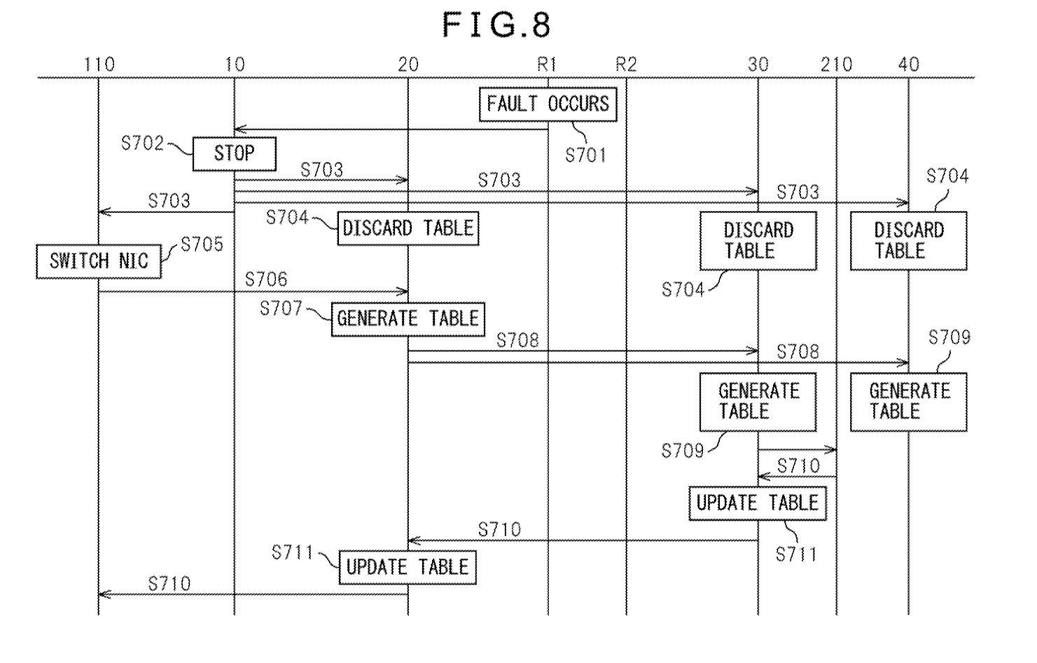

FIG. 8 is a sequence diagram illustrating an example of restoration of a communication system from a fault occurring at the tunnel side network.

At step S701, if a fault occurs at the backbone communication device R1 or a cable connecting to the backbone communication device R1 is disconnected, the communication device 10 detects a fault at the backbone communication device R1 by its monitoring and stops the operation (S702). The other communication device and information processing device 110 detect the stopping of the communication device 10 by monitoring (S703). When the communication devices 20, 30, and 40 detect the stopping of the communication device 10, they discard their communication tables (S704). When the information processing device 110 detects the stopping of the communication device 10, it switches from the NIC connected to the communication device 10 to the other NIC (S705) and sends the information processing device 210 an ARP (Address Resolution Protocol) request (S706). An “ARP request” is a request for transmission of the MAC address from the destination. When the communication device 20 receives an ARP request, it generates a communication table (S707) and transfer the ARP request to other communication devices (S708).

When the information processing device 210 receives an ARP request from the information processing device 110, it generates a table (S709) and sends an ARP response to the information processing device 110 (S710). The communication devices 30 and 20 to which the ARP response is transferred update the tables (S711).

In this way, if open circuit in the network or fault in a backbone communication device etc. occurs, the communication device 10 stops the operation. Due to this, the information processing device 110 which had transferred data through the communication device 10 switches to the communication device 20 for transfer of data.

<Occurrence of Fault at Communication Device>

As a fault at the inside network, an open circuit at the inside network, a down state of a information processing device, etc. may be mentioned. The control unit monitors the state of the inside communication units in preparation for the occurrence of such faults. However, even when such faults occur and the inside communication unit goes down, the device subsequently continues operation without doing anything. As a result, the affected information processing device switches to the redundant system.

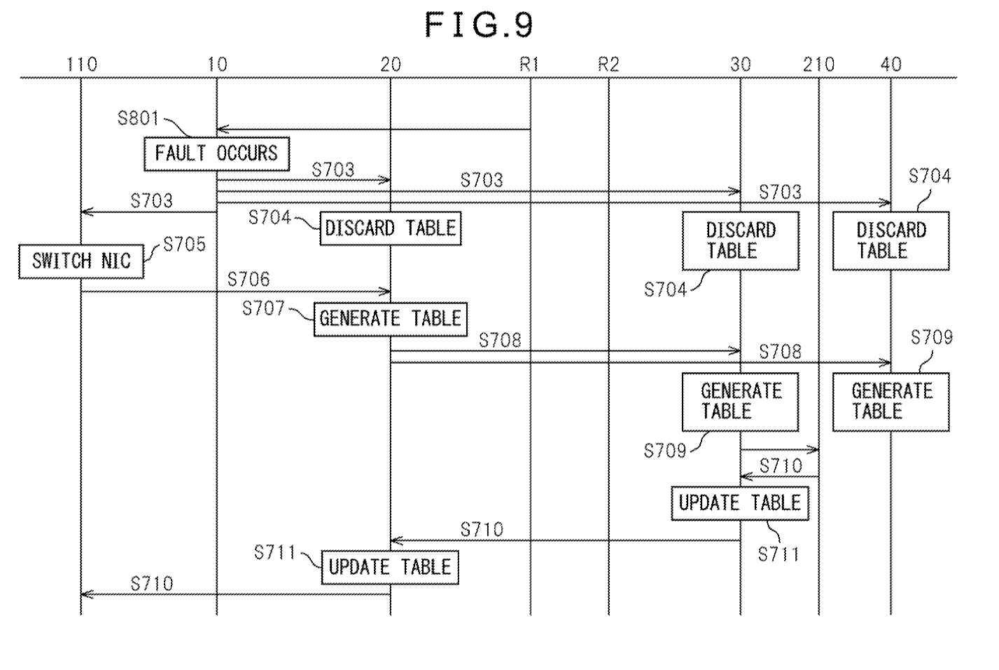

FIG. 9 is a sequence diagram illustrating one example of restoration of a communication system from a fault occurring at the communication device. At step S801 indicated in FIG. 9, a fault occurs at the communication device 10, so another communication device detects the occurrence of the fault at the communication device 10 by monitoring. The other steps S703 to S711 illustrated in FIG. 9 are the same as the steps explained in FIG. 8, so explanations will be omitted.

As illustrated in FIG. 8 and FIG. 9, the information processing device 110 can switch the transfer of data to the other communication device forming the redundant configuration so as to continue operation.

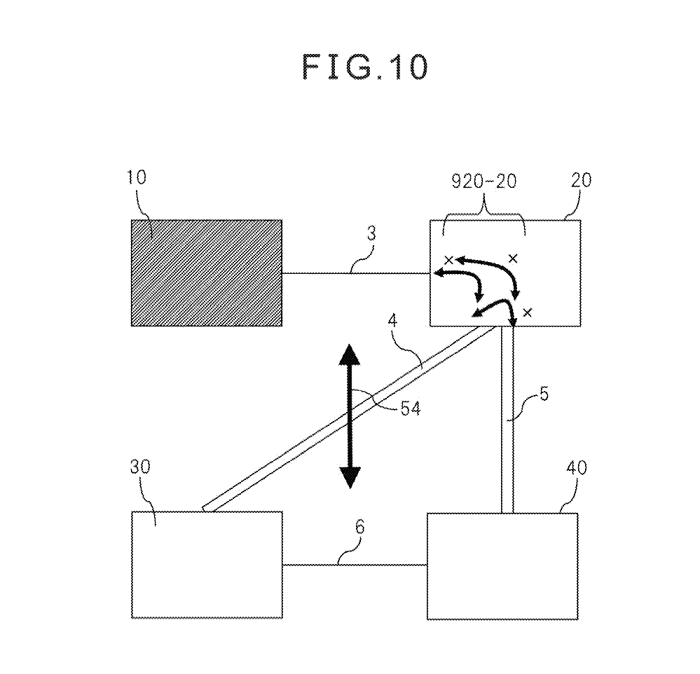

FIG. 10 is a network diagram illustrating one example of a tunnel route after restoration from a fault. Even when the filter rule 920-10 has been set for an ended communication device 10, if a filter rule is set for the other communication device, that is, the communication device 20, it will be understood that no loop is formed. In this way, even when a filter rule is set for a communication device which stops at the time of a fault, the communication system 300 enables data communication without formation of a loop after the communication device stops. Note, when the filter rule 920-10 has not been set for a communication device to be stopped, filter rules are set for at least two other communication devices, so the communication system 300 does not form a loop.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

1. A communication system comprising:
a first communication device that includes first and second communication units and a first encapsulation unit encapsulating or decapsulating data communicated by the first communication unit;
a second communication device that includes a third communication unit communicating data with the second communication unit, a fourth communication unit, and a second encapsulation unit encapsulating or decapsulating data communicated by the third communication unit;
a third communication device that includes a fifth communication unit communicating data with the first or third communication unit, a sixth communication unit, and a third encapsulation unit encapsulating or decapsulating data communicated by the fifth communication unit; and
a fourth communication device that includes a seventh communication unit communicating data with the first or third communication unit, an eighth communication unit communicating data with the fifth communication unit, and a fourth encapsulation unit encapsulating or decapsulating data communicated by the seventh communication unit;
wherein each of the first to fourth communication devices includes a control unit controlling the communication units and the control units of at least two of the first to fourth communication devices control the communication units so as not to transfer data received from other communication devices to these other communication devices.

2. The communication system according to claim 1, wherein the first to fourth communication devices are all in the operating state.

3. The communication system according to claim 1, wherein when an abnormality occurs in any of first to fourth communication devices, the communication device experiencing the abnormality is stopped.

4. A communication system connecting a first communication device that includes first and second communication units and a second communication device that includes third and fourth communication units, the communication system comprising:
a third communication device that includes a fifth communication unit communicating data with the first or third communication unit, a sixth communication unit, a first encapsulation unit that encapsulates or decapsulates data communicated by the fifth communication unit, and a first control unit that controls the fifth and sixth communication unit so as not to transfer data received from other communication devices to these other communication devices; and
a fourth communication device that includes a seventh communication unit communicating data with the first or third communication unit, an eighth communication unit communicating data with the fifth communication unit, a fourth encapsulation unit that encapsulates or decapsulates data communicated by the seventh communication unit, and a second control unit that controls the seventh and eighth communication units so as not to transfer data received from other communication devices to these other communication devices.

5. The communication system according to claim 4, wherein the first to fourth communication devices are all in the operating state.

6. The communication system according to claim 4, wherein when an abnormality occurs in any of first to fourth communication devices, the communication device experiencing the abnormality is stopped.

7. A communication method used in a third communication device and fourth communication device connecting a first communication device including first and second communication units and a second communication device including third and fourth communication units, the communication method comprising:
communicating data by a fifth communication unit of the third communication device with the first or third communication unit and;
encapsulating or decapsulating data communicated with the fifth communication unit by a first encapsulation unit of the third communication device;
controlling the fifth and sixth communication units by a first control unit of the third communication device so as not to transfer data received from other communication devices to these other communication devices;
communicating data by a seventh communication unit of the fourth communication device with the first or third communication unit;
communicating data by an eighth communication unit of the fourth communication device with a sixth communication unit of the third communication device;
encapsulating or decapsulating data communicated with the seventh communication unit by a second encapsulation unit of the fourth communication device; and
controlling the seventh and eighth communication units by a second control unit of the fourth communication device so as not to transfer data received from other communication devices to these other communication device.

8. The communication method according to claim 7, wherein the first to fourth communication devices are all in the operating state.

9. The communication method according to claim 7, wherein when an abnormality occurs in any of first to fourth communication devices, the communication device experiencing the abnormality is stopped.
